(19) United States
(12) Patent Application Publication
(10) Pub. No.: US 2023/0013428 A1
(43) Pub. Date: Jan. 19, 2023

(54) FUNCTION EXECUTION IN SYSTEM MANAGEMENT MODES

(71) Applicant: HEWLETT-PACKARD DEVELOPMENT COMPANY, L.P., Spring, TX (US)

(72) Inventors: Mason GUNYUZLU, Spring, TX (US); Amardeep CHANA, Reading (GB); Robert CRAIG, Spring, TX (US); Tevin RICHARDS, Spring, TX (US)

(21) Appl. No.: 17/374,655

(22) Filed: Jul. 13, 2021

(51) Int. Cl. G06F 9/48; G06F 9/4401; G06F 9/30

(52) U.S. Cl. CPC G06F 9/4812; G06F 9/4418; G06F 9/30098

(57) ABSTRACT

In some examples, executable code causes a processor to execute a first function and enter a system management mode responsive to receipt of a first system management interrupt during the execution of the first function. The executable code causes the processor to pause execution of the first function, save a state of the processor in the system management mode, and exit the system management mode. The executable code causes the processor to execute a second function identified by the first system management interrupt and receive a second system management interrupt to enter the system management mode. The executable code causes the processor to restore the state of the processor in the system management mode and exit the system management mode. The executable code causes the processor to resume execution of the first function after exiting the system management mode.

### BACKGROUND

A function is a collection of executable instructions and parameters for those instructions. A function may be modified by changing the instructions or parameters in memory. A function hook is a set of instructions that are injected into the list of instructions that define a function, thereby adding additional behavior to the function. A function hook usually includes a jump instruction that allows other code (a hook function) to be executed, followed by a return instruction that causes the processor to resume execution of the original function.

### BRIEF DESCRIPTION OF THE DRAWINGS

Various examples will be described below referring to the following figures:

FIG. 1 is a block diagram of a system for function execution in system management mode (SMM) in accordance with various examples.

FIG. 2 is a block diagram of execution environments for function execution in SMM in accordance with various examples described herein.

FIG. 3 is a diagram of a system including a non-transitory computer-readable medium storing executable code for function execution in SMM in accordance with various examples.

FIG. 4 is a diagram of a system including a non-transitory computer-readable medium storing executable code for function execution in SMM in accordance with various examples.

FIG. 5 is a diagram of a system including a non-transitory computer-readable medium storing executable code for function execution in SMM in accordance with various examples.

### DETAILED DESCRIPTION

As described above, a function is a collection of executable instructions and parameters for those instructions. A function may be modified by changing the instructions or parameters in memory. A function hook is a set of instructions that are injected into the list of instructions that define a function, thereby adding additional behavior to the function. A function hook usually includes a jump instruction that allows other code (a hook function) to be executed, followed by a return instruction that causes the processor to resume execution of the original function. However, jumping and executing the hook function may modify the stack and central processing unit (CPU) registers, and jumping back to the original function requires restoring the stack and CPU registers to their original states. Failure to properly restore these registers to their original states may cause unexpected behavior or a CPU crash.

In examples of this disclosure, system management mode (SMM) is used to perform the jump to the hook function. SMM is an operating mode in which all normal execution, including execution of the operating system (OS), is suspended. An alternate computing system is then executed with high privilege. To enter SMM, a system management interrupt (SMI) is generated during operation of a first function. The SMI is injected into the first function to implement the hook. Generation of the SMI causes a transition to SMM. Upon the transition to SMM, the processor stores the contents of the stack and CPU registers to protected memory and begins executing an SMI handler. The SMI handler may jump the processor to a second function (e.g., the hook function). The second function is then executed, and when the second function has finished being executed, the second function generates a second SMI. The second SMI executes the SMI handler to restore the stack and CPU registers and modify the instruction pointer register to point back to the next instruction in the first function. Then, SMM is exited and the first function can continue processing. Therefore, the first function is paused, the second function (e.g., the hook function) is performed via SMM, and then the first function continues processing outside of SMM.

In some examples, function hooks may be used by anti-virus or other security software to detect malicious software. The function hook allows the security software to determine which functions are being called and what data is being passed into and out of those functions. However, malicious software may also attempt to use function hooks to tamper with or work around the security software. To prevent this type of malware, operating systems may restrict the use of function hooks with various techniques. With the examples described herein, function hooks are implemented using SMM, which overcomes these operating system restrictions on function hooks. Also, by using SMM to execute a function, the function may run without itself being hooked by malicious software. SMM executes in a separate execution environment than normal processor functions, and SMM also executes with high privileges. SMM can read and write directly to CPU registers that control execution context and flow of the normal execution state of the processor. With these abilities, SMM can call and execute functions in a manner that hides other entities from viewing and tampering with the executed functions. Also, with SMM, function hooks may be placed anywhere in any function, instead of at the beginning or end of functions like other function hooks.

In some examples, a non-transitory computer-readable medium is provided. The non-transitory computer-readable medium includes all electronic mediums or media of storage, except signals. The non-transitory computer-readable medium stores executable code. When executed by a processor of an electronic device, the executable code causes the processor to execute a first function and enter a SMM responsive to receipt of a first SMI during the execution of the first function. The executable code also causes the processor to pause execution of the first function and save a state of the processor in the SMM. The executable code causes the processor to exit the SMM. The executable code also causes the processor to execute a second function identified by the first SMI. The executable code causes the processor to receive a second SMI to enter the SMM. The executable code causes the processor to restore the state of the processor in the SMM and exit the SMM. The executable code also causes the processor to resume execution of the first function after exiting the SMM.

In some examples, a non-transitory computer-readable medium is provided. The non-transitory computer-readable medium includes all electronic mediums or media of storage, except signals. The non-transitory computer-readable medium stores executable code. When executed by a processor of an electronic device, the executable code causes the processor to execute a first function. The executable code also causes the processor to generate a first SMI to enter a SMM. The executable code causes the processor to pause execution of the first function and save a state of the processor. The executable code also causes the processor to execute a second function in the SMM. The executable code causes the processor to generate a second SMI to exit the SMM. The executable code also causes the processor to restore the saved state of the processor and resume execution of the first function.

In some examples, a non-transitory computer-readable medium is provided. The non-transitory computer-readable medium includes all electronic mediums or media of storage, except signals. The non-transitory computer-readable medium stores executable code. When executed by a processor of an electronic device, the executable code causes the processor to execute a first function. The executable code causes the processor to execute a first SMI during execution of the first function to enter a SMM. The executable code also causes the processor to store a state of the processor in the SMM. The executable code causes the processor to modify an instruction pointer register to point to an instruction of a second function. The executable code also causes the processor to exit the SMM and execute the second function. The executable code causes the processor to receive a second SMI to enter the SMM. The executable code also causes the processor to restore the state of the processor. The executable code causes the processor to modify the instruction pointer register to point to an instruction of the first function, and exit the SMM.

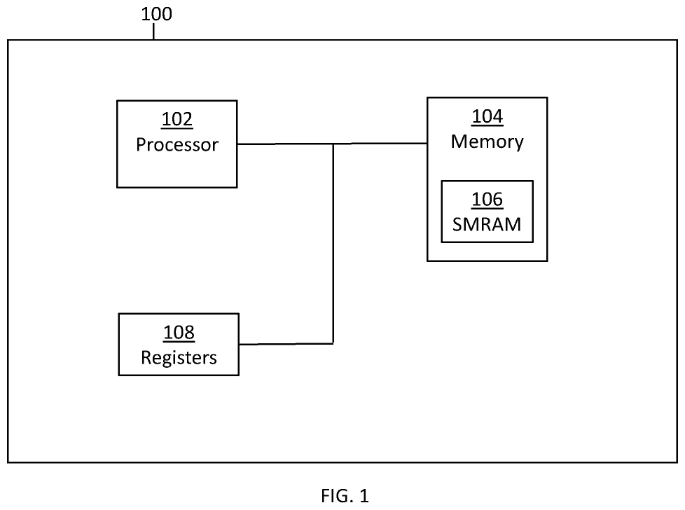

FIG. 1 is a block diagram of a system 100 for function execution in SMM in accordance with various examples. System 100 may be a desktop computer, laptop, notebook, or other electronic device. System 100 uses an x86 instruction set architecture that includes an SMM. SMM, as described above, provides an execution environment separate from the normal execution state of the processor.

System 100 includes processor 102, memory 104, system management random access memory (SMRAM) 106 in the memory 104, and registers 108. Processor 102 may be a CPU, a graphics processing unit, a microprocessor, a microcontroller, or any other component for performing the operations described herein. Memory 104 may be a hard drive, a solid-state drive (SSD), flash memory, random access memory (RAM), or other suitable memory device. Memory 104 may also include multiple memory devices or chips in some examples. SMRAM 106 is a portion of memory 104 that stores executable code used for SMM operations. SMRAM 106 may be used to save the state of processor 102 before system 100 enters SMM in one example. Registers 108 may be processor registers used by processor 102 to store data and/or addresses during execution of functions by processor 102. Registers 108 may be other types of registers as well in other examples. The state of registers 108 may be saved in SMRAM 106 when system 100 enters SMM. The state of registers 108 may be saved elsewhere in other examples.

In system 100, SMM is used to execute a hook function to ensure the hook function executes without being tampered with or modified by other software, such as malicious software. SMM also enables the hook function to execute if the operating system restricts other methods of performing function hooks.

Function hooks that do not use SMM are often implemented in the prologue (entry point) or epilogue (end) of the function. These types of function hooks are difficult to implement in the middle of a function. In examples herein, function hooks are implemented using SMM. Entering SMM may be accomplished in a variety of ways, and SMM may even be entered in the middle of a function. To enter SMM, an SMI is generated. An SMI may be invoked by a motherboard hardware or chipset signal via a designated pin of the processor chip in one example. In another example, a software SMI may be triggered by system software via an input/output (I/O) access to a special location, such as a specific port. In another example, SMI may be triggered by an I/O write to a specific location that the processor chip is programmed to act upon. These different methods for entering SMM may be accomplished at points within a function other than the prologue or epilogue, which provides more flexibility than alternative function hooks.

In one example, a “mov” instruction written to a specific I/O port generates an SMI during a first function being executed by processor 102. The first function may be a function from the runtime operating system executing in long mode. Processor 102 enters SMM after receiving the SMI. Transitioning to SMM allows functions to be performed outside of the control of the runtime operating system. After processor 102 transitions to SMM, processor 102 saves the contents of registers 108 (e.g., the state of processor 102) to SMRAM 106 (or to other memory) and then begins execution of an SMI handler. Processor 102 switches to a separate SMM operating environment, defined by a new address space. The SMI handler is a system management software executive that executes in the SMM environment, and the code and data of the SMI handler resides in SMRAM 106 in one example. In SMM, processor 102 executes SMI handler code to perform operations. The SMI handler may also use memory 104 to perform operations in some examples. After the SMI handler has completed its operations, it executes a resume (RSM) instruction to exit SMM. RSM reads the processor state data stored in SMRAM 106, and restores the state of processor 102, including the contents of registers 108. After restoration of the state of processor 102, processor 102 continues executing the first function that was interrupted by the SMI.

In examples herein, a first function being executed in the normal operating environment of processor 102 may be interrupted by an SMI so a second function can be executed using SMM. After entering SMM, the SMI handler could execute the second function in one example. In another example, the SMI handler could jump the processor 102 to the second function, and the second function could be executed outside of SMM. To do this, the SMI handler can save the values in registers 108 and modify the instruction pointer register, along with any other appropriate registers, before exiting SMM. This process allows the second function to begin execution. After the second function executes, the second function generates another SMI. The SMI handler restores the values back to registers 108 and modifies the instruction pointer register to point back to the next instruction in the first function. The first function may then continue execution at the point where it was interrupted by the SMI.

In the example described above, SMM performs the jump by modifying the instruction pointer register. Therefore, this jump is hidden from any entity outside of SMM. As an example, malicious software may be unaware of the jump because it occurs within SMM. Because this jump is hidden from malicious software, it is more difficult for malicious software to tamper with the jump or tamper with the second function. Examples herein may therefore be useful for performing antivirus or anti-malware functions that are difficult for malicious software to counter. Malicious software may also be unable to determine which function is performed with the function hook because the SMI is generated by just the “mov” instruction.

SMM is designed to restore the registers 108 and the state of processor 102. Therefore, the second function that interrupts the first function does not have to perform restoration of the registers 108 or the state of processor 102. Using SMM to perform the restoration allows the second function to be easier to implement and portable.

In examples herein, the hook functions may perform a variety of actions besides antivirus operations. For example, the second function may record information about the first function, such as process name, process identification (ID) number, or other information. The second function could also obtain information for quality assurance, such as data on how or why a piece of software is crashing or malfunctioning. Hook functions could be placed into certain OS functions using SMM in some examples to provide information on how those OS functions are operating.

In another example, more than one hook function may be executed while execution of the first function is paused by SMM. Any number of hook functions may be executed by SMM or executed outside of SMM before execution of the first function is resumed. For example, execution of the first function may be paused via SMM, and then a second function, third function, fourth function, etc., may be executed. After the last hook function is executed, SMM may restore the operating state for the first function and the first function may resume execution.

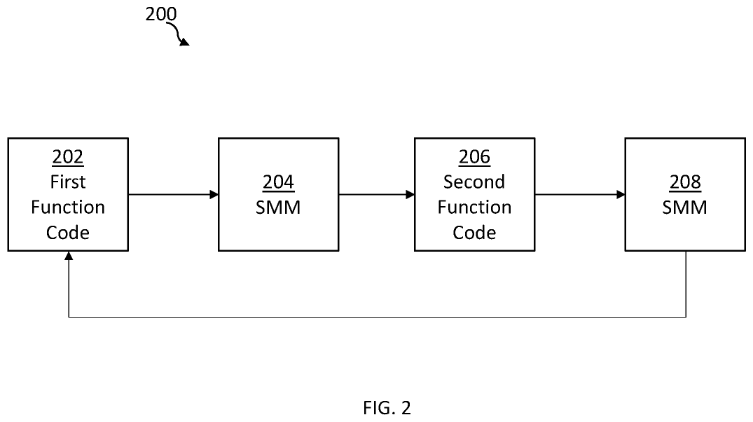

FIG. 2 is a block diagram 200 of execution environments for function execution in SMM in accordance with various examples described herein. The execution environment begins at block 202, where first function code is executed. Block 202 represents a first function executing in a normal execution state of a processor, such as processor 102 in one example.

During execution of the first function in block 202, an SMI is received by processor 102. Processor 102 transitions to SMM, represented by block 204. At block 204, processor 102 saves the values in CPU registers (such as registers 108) and the state of processor 102 in SMRAM 106 or in other locations in memory 104. These values and state represent the state of processor 102 executing the first function code at the time that the SMI was received by processor 102. These values and state are stored so execution of the first function code may be resumed after the SMM operations are complete.

At block 204, SMM operations may be performed. In this example, SMM exits and jumps to the second function code in block 206. The second function code executed in block 206 may be executed by processor 102. The second function code is the hook function in this example. Execution of the first function code is suspended while the second function code is executed in block 206.

After execution of the second function code is complete in block 206, the second function code generates another SMI. This SMI enters processor 102 into SMM at block 208. SMM at block 208 operates to restore the registers 108 and state of processor 102 to the state that existed when the execution of the first function code was interrupted by the SMI during block 202. As shown in FIG. 2, when the state of processor 102 is restored, the process returns to block 202 to continue execution of the first function code at the point the first function code was interrupted. Block diagram 200 provides one example of function execution using SMM that is reliable and that allows the second function to be executed at any time during execution of the first function.

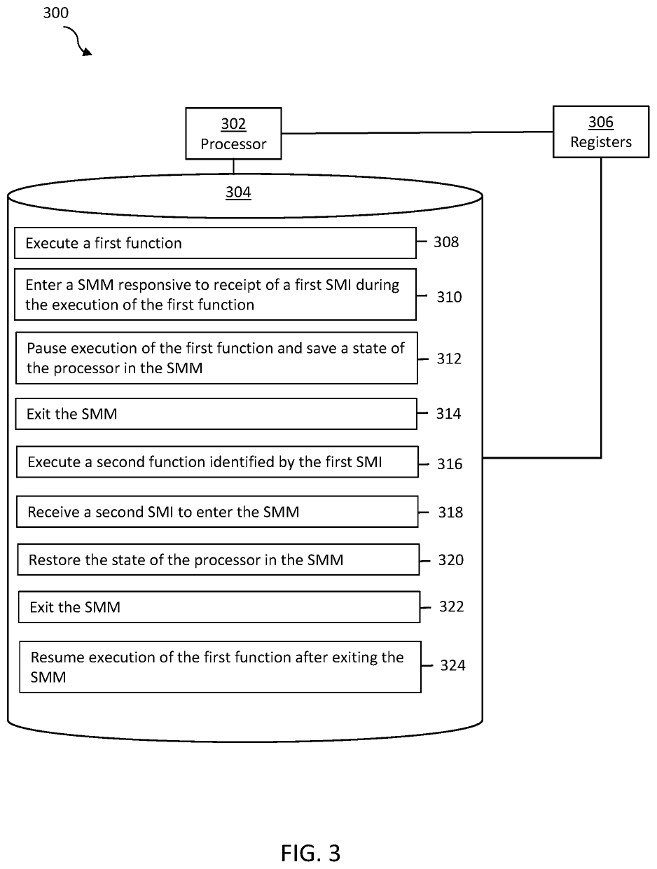

FIG. 3 is a diagram of a system 300 including a non-transitory computer-readable medium storing executable code for function execution in SMM in accordance with various examples described herein. System 300 includes a processor 302, a storage device 304, and registers 306. Storage device 304 includes executable code 308, 310, 312, 314, 316, 318, 320, 322, and 324. Processor 302 may be processor 102 shown in FIG. 1 in some examples. Storage device 304 may include memory 104 shown in FIG. 1 in some examples. Registers 306 may include registers 108 shown in FIG. 1 in some examples.

System 300 provides function execution in SMM as described herein. Processor 302 executes executable code 308, 310, 312, 314, 316, 318, 320, 322, and 324 to execute a hook function using SMM. Processor 302 executes executable code 308 to execute a first function. The first function executes in a normal operating environment using processor 302, registers 306, and any suitable data stored in storage device 304 or elsewhere.

Processor 302 executes executable code 310 to enter an SMM responsive to receipt of a first SMI during the execution of the first function. As described above, the SMI may be generated using one of a variety of methods.

Processor 302 executes executable code 312 to pause execution of the first function and save a state of the processor 302 in the SMM. In one example, the state of the processor 302 may be saved in SMRAM, such as SMRAM 106 in FIG. 1. The values in registers 306 may be saved in one example, along with other information regarding the state of processor 302. Processor 302 then executes executable code 314 to exit the SMM. In some examples, an RSM instruction is used to exit SMM.

Processor 302 executes executable code 316 to execute a second function identified by the first SMI. The second function is the hook function in this example. By using SMM to jump to the second function, the second function may be protected from tampering by other functions, such as malware.

Processor 302 executes executable code 318 to receive a second SMI to enter the SMM. The second SMI is generated after the second function finishes execution in one example. Processor 302 then executes executable code 320 to restore the state of the processor 302 in the SMM. The state of processor 302 is restored to the state that existed when the first SMI was received during execution of the first function.

Processor 302 executes executable code 322 to exit the SMM. An RSM instruction may be used to exit SMM. Processor 302 then executes executable code 324 to resume execution of the first function after exiting the SMM.

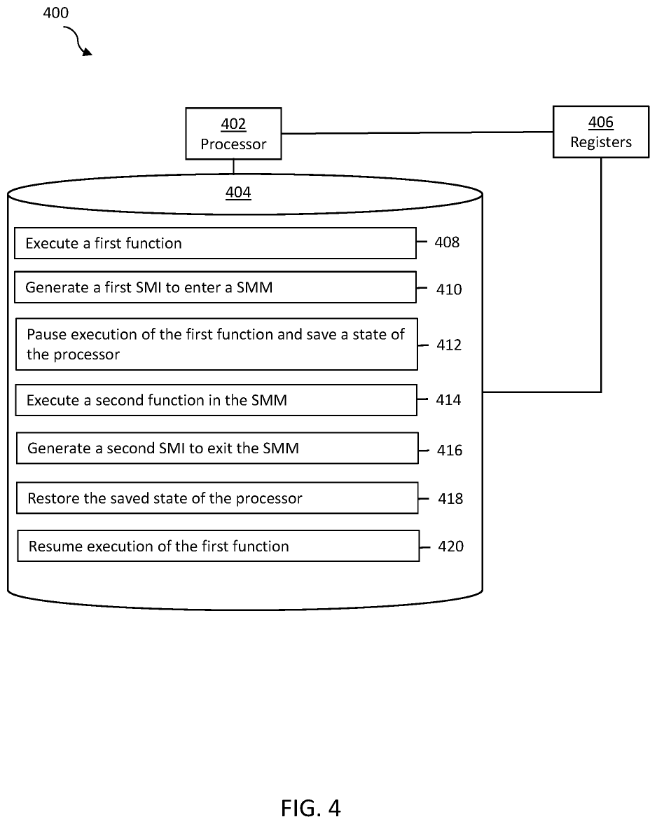

FIG. 4 is a diagram of a system 400 including a non-transitory computer-readable medium storing executable code for function execution in SMM in accordance with various examples described herein. System 400 includes a processor 402, a storage device 404, and registers 406. Storage device 404 includes executable code 408, 410, 412, 414, 416, 418, and 420. Processor 402 may be processor 102 shown in FIG. 1 in some examples. Storage device 404 may include memory 104 shown in FIG. 1 in some examples. Registers 406 may include registers 108 shown in FIG. 1 in some examples.

System 400 provides function execution in SMM as described herein. Processor 402 executes executable code 408, 410, 412, 414, 416, 418, and 420 to execute a hook function using SMM. Processor 402 executes executable code 408 to execute a first function. The first function executes in a normal operating environment using processor 402, registers 406, and any suitable data stored in storage device 404 or elsewhere.

Processor 402 executes executable code 410 to generate a first SMI to enter a SMM. The first SMI may be generated using any suitable method as described above. In one example, a “mov” instruction written to a specific I/O port generates an SMI. Processor 402 executes executable code 412 to pause execution of the first function and save a state of the processor 402. The state of the processor 402 and the values in registers 406 may be saved in SMRAM, such as SMRAM 106, in one example.

Processor 402 executes executable code 414 to execute a second function in the SMM. As described above, SMM may execute the second function in some examples. After the execution of the second function, processor 402 executes executable code 416 to generate a second SMI to exit the SMM. The second function may generate the second SMI after it finishes execution in one example.

Processor 402 executes executable code 418 to restore the saved state of the processor 402. The saved state may be restored from SMRAM 106 in one example. The saved state may include the values in registers 406. Processor 402 then executes executable code 420 to resume execution of the first function. The first function continues execution in the normal processing environment at the point that it was interrupted by the SMI of executable code 410.

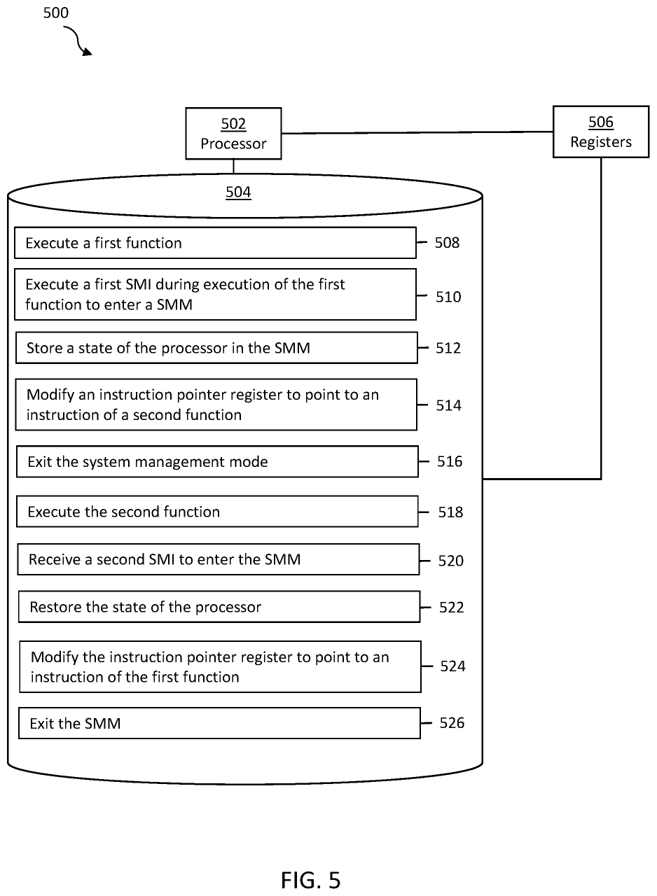

FIG. 5 is a diagram of a system 500 including a non-transitory computer-readable medium storing executable code for function execution in SMM in accordance with various examples described herein. System 500 includes a processor 502, a storage device 504, and registers 506. Storage device 504 includes executable code 508, 510, 512, 514, 516, 518, 520, 522, 524, and 526. Processor 502 may be processor 102 shown in FIG. 1 in some examples. Storage device 504 may include memory 104 shown in FIG. 1 in some examples. Registers 506 may include registers 108 shown in FIG. 1 in some examples.

System 500 provides function execution in SMM as described herein. Processor 502 executes executable code 508, 510, 512, 514, 516, 518, 520, 522, 524, and 526 to execute a hook function using SMM. Processor 502 executes executable code 508 to execute a first function. The first function executes in a normal operating environment using processor 502, registers 506, and any suitable data stored in storage device 504 or elsewhere.

Processor 502 executes executable code 510 to execute a first SMI during execution of the first function to enter a SMM. The SMI may be generated using any suitable method. Processor 502 executes executable code 512 to store a state of the processor 502 in the SMM. The state of the processor may be stored in SMRAM 106 in one example. The values in registers 506 may be stored as well.

Processor 502 executes executable code 514 to modify an instruction pointer register to point to an instruction of a second function. The instruction pointer register previously pointed to an instruction of the first function before the SMI was generated. By pointing to an instruction of the second function, the second function can begin execution. Processor 502 executes executable code 516 to exit the SMM. Processor 502 then executes executable code 518 to execute the second function.

After the second function completes execution, processor 502 executes executable code 520 to receive a second SMI to enter the SMM. The SMI may be generated using an appropriate instruction after the second function completes execution. Processor 502 then executes executable code 522 to restore the state of the processor 502. The state of the processor 502 may be stored in SMRAM 106 as described above.

Processor 502 executes executable code 524 to modify the instruction pointer register to point to an instruction of the first function. The instruction pointer register is modified to point to the next instruction of the first function that was to be executed before the SMI was executed by executable code 510 above. Processor 502 then executes executable code 526 to exit the SMM. After SMM is exited, the first function may resume execution in the normal processing environment.

In examples herein, SMM may call and execute hook functions in a manner that hides other entities from viewing and tampering with the hook functions. Also, with SMM, function hooks may be placed anywhere in any function, instead of at the beginning or end of functions like other function hooks. SMM also allows the hook function to execute if the operating system restricts other methods of performing function hooks.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium storing executable code, which, when executed by a processor of an electronic device, causes the processor to:
execute a first function;
enter a system management mode responsive to receipt of a first system management interrupt during the execution of the first function;
pause execution of the first function and save a state of the processor in the system management mode;
exit the system management mode;
execute a second function identified by the first system management interrupt;
receive a second system management interrupt to enter the system management mode;
restore the state of the processor in the system management mode;
exit the system management mode; and
resume execution of the first function after exiting the system management mode.

2. The non-transitory computer-readable medium of claim 1, wherein the executable code, when executed by the processor, causes the processor to save the state by storing data from a register in system management random access memory.

3. The non-transitory computer-readable medium of claim 1, wherein the state of the processor includes values stored in a processor register.

4. The non-transitory computer-readable medium of claim 1, wherein the state of the processor includes the state of an instruction pointer register.

5. The non-transitory computer-readable medium of claim 1, wherein the executable code, when executed by the processor, causes the processor to identify the second function by the first system management interrupt with a jump to an instruction of the second function.

6. A non-transitory computer-readable medium storing executable code, which, when executed by a processor of an electronic device, causes the processor to:
execute a first function;
generate a first system management interrupt to enter a system management mode;
pause execution of the first function and save a state of the processor;
execute a second function in the system management mode;
generate a second system management interrupt to exit the system management mode;
restore the saved state of the processor; and
resume execution of the first function.

7. The non-transitory computer-readable medium of claim 6, wherein the executable code, when executed by the processor, causes the processor to generate the first system management interrupt by writing an instruction to an input/output port.

8. The non-transitory computer-readable medium of claim 6, wherein the executable code, when executed by the processor, causes the processor to restore the saved state of the processor by modifying an instruction pointer register to point to an instruction of the first function.

9. The non-transitory computer-readable medium of claim 6, wherein the executable code, when executed by the processor, causes the processor to execute the second function by modifying an instruction pointer register to point to an instruction of the second function.

10. The non-transitory computer-readable medium of claim 6, wherein the executable code, when executed by the processor, causes the processor to execute a third function in the system management mode before exiting the system management mode.

11. A non-transitory computer-readable medium storing executable code, which, when executed by a processor of an electronic device, causes the processor to:
execute a first function;
execute a first system management interrupt during execution of the first function to enter a system management mode;
store a state of the processor in the system management mode;
modify an instruction pointer register to point to an instruction of a second function;
exit the system management mode;
execute the second function;
receive a second system management interrupt to enter the system management mode;
restore the state of the processor;
modify the instruction pointer register to point to an instruction of the first function; and
exit the system management mode.

12. The non-transitory computer-readable medium of claim 11, wherein the executable code, when executed by the processor, causes the processor to execute the first system management interrupt by writing an instruction to an input/output port.

13. The non-transitory computer-readable medium of claim 11, wherein the state of the processor is stored in system management random access memory.

14. The non-transitory computer-readable medium of claim 11, wherein the state of the processor includes values stored in a processor register.

15. The non-transitory computer-readable medium of claim 11, wherein the executable code, when executed by the processor, causes the processor to execute a third function before the processor receives the second system management interrupt.
